(19) United States
(12) Patent Application Publication
(10) Pub. No.: US 2026/0162580 A1
(43) Pub. Date: Jun. 11, 2026

(54) DISPLAY DEVICE AND OPERATING METHOD FOR DISPLAY DEVICE

(71) Applicants: Innolux Corporation, Miaoli County (TW); CARUX TECHNOLOGY PTE. LTD., SINGAPORE (SG)

(72) Inventors: Tsan-Po Weng, Tainan (TW); Chia-Ling Wu, Tainan (TW); Nai-Fang Hsu, Miaoli County (TW)

(73) Assignees: Innolux Corporation, Miaoli County (TW); CARUX TECHNOLOGY PTE. LTD., SINGAPORE (SG)

(21) Appl. No.: 19/393,594

(22) Filed: Nov. 19, 2025

(30) Foreign Application Priority Data
Dec. 5, 2024 (CN) 202411781965.9

(51) Int. Cl. G09G 3/20; G06F 3/041; G06F 3/0488; G06T 7/90

(52) U.S. Cl. CPC G09G 3/2003; G06F 3/04164; G06F 3/0488; G06T 7/90

(57) ABSTRACT

A display device and an operating method for the display device are provided. The display device includes an image data circuit, a recognition circuit and a compensation circuit. The image data circuit outputs an image data. The recognition circuit receives the image data and recognizes the image data to generate a recognition result. The compensation circuit generates a compensation signal according to the recognition result, and compensates the image data according to the compensation signal.

### CROSS-REFERENCE TO RELATED APPLICATION

This application claims the priority benefit of China patent application serial no. 202411781965.9, filed on Dec. 5, 2024. The entirety of each of the above-mentioned patent applications is hereby incorporated by reference herein and made a part of this specification.

### BACKGROUND

### Technical Field

The present disclosure relates to a display device and an operation method for the display device, particularly a display device and operation method capable of compensating image data.

### Description of Related Art

The display device may generate data signals according to image data, and use the data signals to display an image corresponding to the image data. At least based on different designs or scenarios, the display device may experience abnormal grayscale patterns in the displayed image. Therefore, at least based on different designs or scenarios, how to compensate the image data to improve the grayscale uniformity of the display device is one of the research focuses for those skilled in the field.

### SUMMARY

The disclosure provides a display device and an operation method capable of compensating image data.

According to an embodiment of the disclosure, the display device includes an image data circuit, a recognition circuit, and a compensation circuit. The image data circuit outputs image data. The recognition circuit is electrically connected to the image data circuit. The recognition circuit receives the image data and recognizes the image data to generate a recognition result. The compensation circuit is electrically connected to the recognition circuit. The compensation circuit generates a compensation signal according to the recognition result, and compensates the image data according to the compensation signal.

According to an embodiment of the disclosure, the operation method is for a display device. The operation method includes: receiving an input image from an automotive host and generating image data according to the input image; receiving the image data and recognizing the image data to generate a recognition result; generating a compensation signal according to the recognition result; and compensating the image data according to the compensation signal.

Based on the above, the display device recognizes the image data to generate a recognition result, and generates a compensation signal according to the recognition result. The display device compensates the image data according to the compensation signal. The display device may compensate the image data based on different designs or scenarios. As a result, the grayscale uniformity of the display device can be improved.

### BRIEF DESCRIPTION OF THE DRAWINGS

FIG. 1 is a schematic diagram illustrating a display device according to an embodiment of the disclosure.

FIG. 2 is a flowchart illustrating an operation method according to an embodiment of the disclosure.

FIG. 3 is a schematic diagram illustrating a display device according to an embodiment of the disclosure.

FIG. 4 is a schematic diagram illustrating touch electrodes and scan line groups according to an embodiment of the disclosure.

FIG. 5 is a schematic diagram illustrating a compensation operation according to an embodiment of the disclosure.

FIG. 6 is a schematic diagram illustrating a display device according to an embodiment of the disclosure.

FIG. 7 is a flowchart illustrating an operation method according to an embodiment of the disclosure.

FIG. 8 is a flowchart illustrating an operation method according to an embodiment of the disclosure.

FIG. 9 is a flowchart illustrating an operation method according to an embodiment of the disclosure.

FIG. 10 is a flowchart illustrating an operation method according to an embodiment of the disclosure.

### DESCRIPTION OF THE EMBODIMENTS

The disclosure may be understood through the following detailed description in conjunction with the accompanying drawings as described below. It should be noted that, for the purpose of clear illustration and easy understanding by readers, each drawing of the disclosure illustrates a part of the electronic device, and some elements in each drawing may not be drawn to scale. Furthermore, the number and size of each device shown in the drawings are only illustrative and are not intended to limit the scope of the disclosure.

Certain terminology is used throughout the description and the following claims to refer to specific elements. As those skilled in the field will understand, electronic device manufacturers may refer to elements by different names. The document does not intend to distinguish between elements that differ in name but not in function. In the following description and in the claims, the terms “include”, “comprise”, and “have” are used in an open-ended manner, and thus should be interpreted to mean “including, but not limited to”. Therefore, when the terms “include”, “comprise”, and/or “have” are used in the description of the disclosure, it will indicate the presence of corresponding features, regions, steps, operations, and/or elements, but is not limited to the presence of one or more corresponding features, regions, steps, operations, and/or elements.

It should be understood that when an element is referred to as being “coupled to”, “connected to”, or “electrically connected to” another element, the element may be directly connected to the other element and may establish direct electrical connection, or there may be intermediate elements between these elements for relaying electrical connection (indirect electrical connection). In contrast, when an element is referred to as being “directly coupled to”, “directly electrically connected to”, or “directly connected to” another element, there are no intermediate elements present.

Although terms such as first, second, third, etc. may be used to describe various elements, these elements are not limited by these terms. These terms are only used to distinguish one element from other elements in the specification. Claims may not use the same terms, but may use terms such as first, second, third, etc. relative to the order in which the elements are claimed. Therefore, in the following description, a first element may be a second element in the claims.

The display device disclosed may include pixel circuits. The pixel circuits may include light-emitting diodes which may, for example, include organic light-emitting diodes (OLED), mini LEDs, micro LEDs, or quantum dot LEDs (which may include QLED, QDLED), or other suitable materials, or combinations thereof, but are not limited thereto. The display device may, for example, include a tiled display device, but is not limited thereto. The antenna device may, for example, be a liquid crystal antenna, but is not limited thereto. The antenna device may, for example, include an antenna tiling device, but is not limited thereto. It should be noted that the electronic device may be any combination of the aforementioned arrangements, but is not limited thereto. Furthermore, the shape of the electronic device may be rectangular, circular, polygonal, a shape with curved edges, or other suitable shapes. The electronic device may have peripheral systems such as driving systems, control systems, light source systems, etc. to support the display device, antenna device, or tiling device, but the disclosure is not limited thereto. The sensing device may include a camera or infrared sensor or fingerprint sensor, etc., but the disclosure is not limited thereto. In some embodiments, the sensing device may also include a flash, infrared (IR) light source, other sensors, electronic elements, or combinations thereof, but is not limited to these.

In the disclosure, embodiments use “pixel” or “pixel unit” as a unit for describing a specific area containing at least one functional circuit for at least one specific function. The area of a “pixel” depends on the unit used to provide a specific function, adjacent pixels may share the same parts or wires, but may also include their own specific parts within them. For example, adjacent pixels may share the same scan line or the same data line, but pixels may also have their own transistors or capacitors.

It should be noted that the technical features in the different embodiments described below may be replaced, recombined, or mixed with each other to form another embodiment without departing from the spirit of the disclosure.

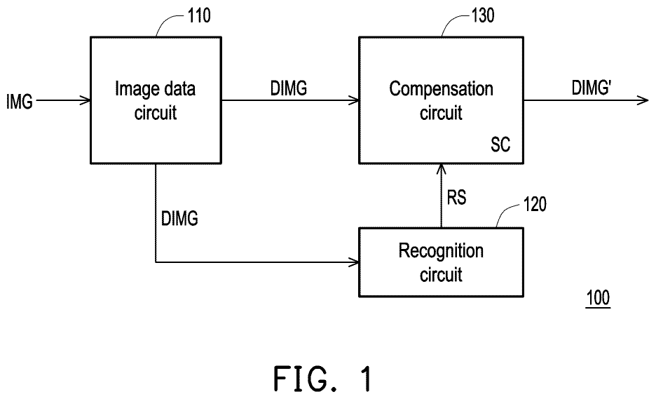

Please refer to FIG. 1, FIG. 1 is a schematic diagram of a display device according to an embodiment of the disclosure. In the embodiment, the display device 100 includes an image data circuit 110, a recognition circuit 120, and a compensation circuit 130. The image data circuit 110 outputs image data DIMG. For example, the image data circuit 110 may generate image data DIMG according to input image IMG. The recognition circuit 120 is electrically connected to the image data circuit 110. The recognition circuit 120 receives the image data DIMG and recognizes the image data DIMG to generate a recognition result RS. In the embodiment, the compensation circuit 130 is electrically connected to the recognition circuit 120. The compensation circuit 130 generates a compensation signal SC according to the recognition result RS. The compensation circuit 130 compensates the image data DIMG according to the compensation signal SC to generate a compensated image data DIMG′.

It should be noted, the display device 100 recognizes the image data DIMG to generate the recognition result RS, and generates the compensation signal SC according to the recognition result RS. The display device 100 also uses the compensation signal SC to compensate the image data DIMG. The display device 100 can compensate the image data DIMG based on different designs or scenarios. In this way, the grayscale uniformity of the display device 100 can be improved.

In the embodiment, the image data DIMG may be, for example, a digital signal. The compensation signal SC may be, for example, a digital adjustment value. The data signals SD and SD1 are, for example, analog signals (such as voltage signals, current signals, or PAM signals). Therefore, based on the compensation signal SC, the voltage value, current value, or amplitude of the data signal SD can be adjusted to generate the data signal SD1. Consequently, the corresponding grayscale is also adjusted.

For example, the recognition circuit 120 may obtain at least one compensation display position of the display device 100 according to the image data DIMG. The compensation display position may be a position of a pixel or sub-pixel to be compensated. The recognition circuit 120 generates the recognition result RS according to the at least one compensation display position.

As another example, the recognition circuit 120 may generate the recognition result RS according to a polarity inversion of the image data DIMG. The recognition result RS may be at least one compensation display position of the display device.

In the embodiment, the compensation circuit 130 may, for example, compensate the image data DIMG using the “Demura” compensation operation well-known to those skilled in the field.

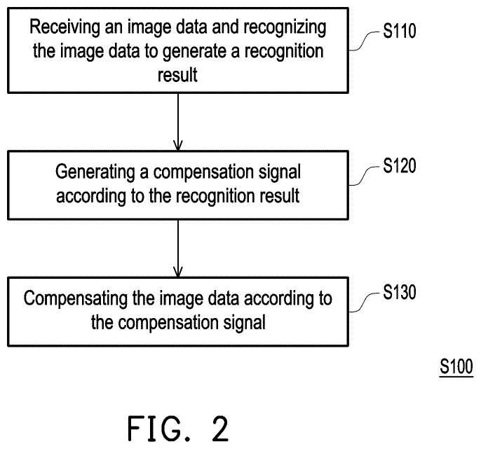

Please refer to FIG. 1 and FIG. 2, FIG. 2 is a flowchart of an operation method according to an embodiment of the disclosure. In the embodiment, the operation method S100 is applicable to the display device 100. The operation method S100 includes steps S110 to S130. In the step S110, the display device 100 receives the image data DIMG and recognizes the image data DIMG to generate the recognition result RS. In the step S120, the display device 100 generates the compensation signal SC according to the recognition result RS. In the step S130, the display device 100 compensates the image data DIMG according to the compensation signal SC.

The embodiment examples of steps S110 to S130 have been clearly explained in the embodiment of FIG. 1, so they will not be repeated here.

For example, the operation method S100 could be applied to the automotive field. Therefore, before the step S110, the display device 100 may receive an input image IMG from an automotive host. The display device 100 may generate the image data DIMG according to the input image IMG.

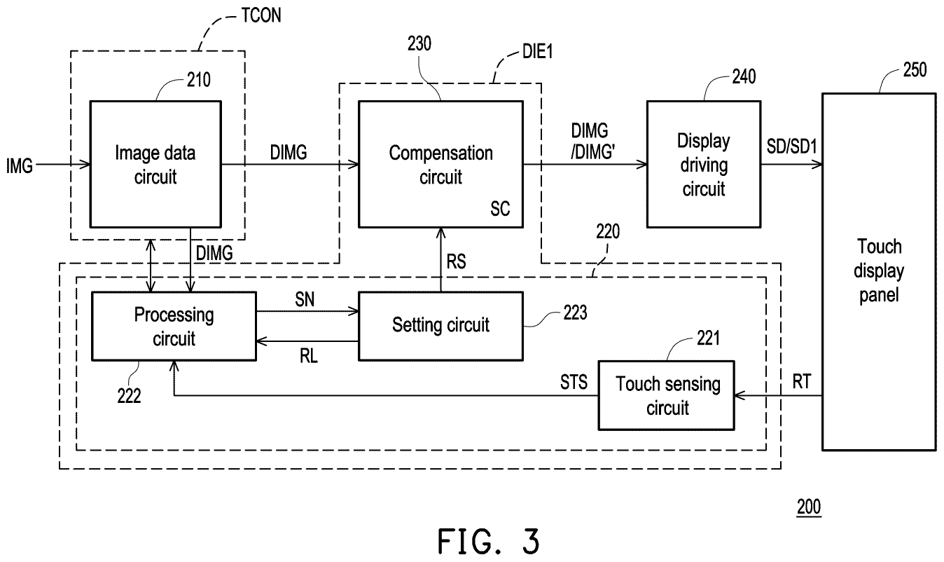

Please refer to FIG. 3, FIG. 3 is a schematic diagram of a display device according to an embodiment of the disclosure. In the embodiment, the display device 200 may be a touch display device. The display device 200 includes an image data circuit 210, a recognition circuit 220, a compensation circuit 230, a display driving circuit 240, and a touch display panel 250. The image data circuit 210 is, for example, set in the timing controller TCON. The image data circuit 210 may generate the image data DIMG according to the input image IMG.

The recognition circuit 220 is electrically connected to the image data circuit 210 and the touch display panel 250. The recognition circuit 220 receives the image data DIMG and recognizes the image data DIMG to generate the recognition result RS. In addition, the recognition circuit 220 receives the image data DIMG and recognizes the image data DIMG to generate the recognition result RS. Furthermore, the recognition circuit 220 may also receive the touch result RT and generate the recognition result RS according to the touch result RT and the image data DIMG.

The compensation circuit 230 is electrically connected to the image data circuit 210, the recognition circuit 220 and the display driving circuit 240. The compensation circuit 230 generates the compensation signal SC according to the recognition result RS. The compensation circuit 230 compensates the image data DIMG according to the compensation signal SC to generate the compensated image data DIMG′. The display driving circuit 240 is electrically connected to the compensation circuit 230 and the touch display panel 250. The display driving circuit 240 generates the data signal SD1 according to the compensated image data DIMG′. The touch display panel 250 receives the data signal SD1 and displays the image according to the data signal SD1.

Moreover, when the compensation signal SC is not received, the compensation circuit 230 may provide the image data DIMG to the display driving circuit 240. The display driving circuit 240 then generates the data signal SD according to the image data DIMG.

In the embodiment, the recognition circuit 220 and the compensation circuit 230 are integrated in the same chip DIE1, but the disclosure is not limited thereto.

In the embodiment, the recognition circuit 220 includes a touch sensing circuit 221, a processing circuit 222, and a setting circuit 223. The touch sensing circuit 221 is electrically connected to the touch display panel 250. The touch sensing circuit 221 receives the touch result RT from the touch display panel 250 and converts the touch result RT into a touch sensing signal STS. The touch sensing circuit 221 may be implemented, for example, by any form of analog front-end circuit, but the disclosure is not limited thereto.

In the embodiment, the processing circuit 222 is electrically connected to the touch sensing circuit 221 and the image data circuit 210. The processing circuit 222 receives the touch sensing signal STS and the image data DIMG. The processing circuit 222 generates a notification signal SN. In the embodiment, the setting circuit 223 is electrically connected to the processing circuit 222 and the compensation circuit 230. The setting circuit 223 generates the recognition result RS according to the notification signal SN.

For example, the processing circuit 222 generates the notification signal SN according to an inversion frequency of the polarity of the image data DIMG. In other words, the compensation circuit 230 may compensate the image data DIMG according to the inversion frequency of the polarity of the image data DIMG.

For example, the processing circuit 222 generates the notification signal SN according to the polarity of the image data DIMG and the touch position. For example, the processing circuit 222 generates the notification signal SN according to the polarity of the image data DIMG and the touch situation of the touch position. In other words, the compensation circuit 230 may compensate the image data DIMG according to the polarity of the image data DIMG and the touch position.

Further, for example, when continuous or frequent touch behaviors occur at at least one of specific touch position, the common voltage in the touch display panel 250 may be interfered and offset. In the embodiment, the processing circuit 222 may obtain the touch behavior according to the touch sensing signal STS, and generate the notification signal SN according to the polarity of the image data DIMG and the touch behavior. Therefore, the compensation circuit 230 may compensate the image data DIMG according to the image data DIMG and the touch behavior.

In the embodiment, the operation method S100 could be applied to the display device 200.

In the embodiment, the setting circuit 223 may provide a layout information RL according to a layout of the touch electrodes. The processing circuit 222 generates the notification signal SN according to the layout information RL.

In the embodiment, the processing circuit 222 and the setting circuit 223 are respectively, for example, a Central Processing Unit (CPU), or other programmable general-purpose or special-purpose microprocessors, Digital Signal Processors (DSP), programmable controllers, Application Specific Integrated Circuits (ASIC), Programmable Logic Devices (PLD) or other similar devices or combinations of these devices, which may load and execute computer programs.

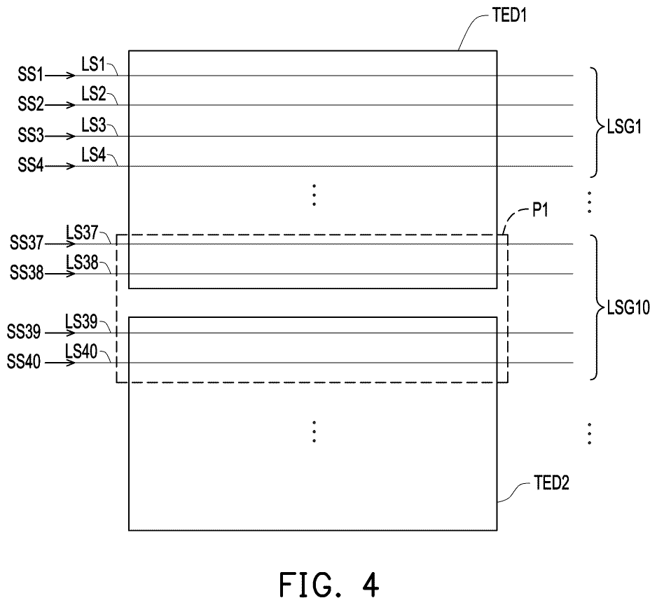

Please refer to FIG. 3 and FIG. 4, FIG. 4 is a schematic diagram illustrating touch electrodes and scan line groups according to an embodiment of the disclosure. In the embodiment, taking the “4 H-line” specification as an example, the scan line group LSG1 includes scan lines LS1˜LS4. The scan line group LSG10 includes scan lines LS37˜LS40. The interference of the transitions of the scan signals SS1˜SS4 of the scan lines LS1˜LS4 in the scan line group LSG1 are compensated for each other. For example, the interference generated by the falling edge or rising edge of the scan signal SS1 may be compensated by the interference of the rising edge or falling edge of one of the scan signals SS2˜SS4, thereby achieving feedthrough compensation. For example, the interference generated by the falling edge or rising edge of the scan signal SS2 may be compensated by the rising edge or falling edge of one of the scan signals SS1, SS3, SS4, and so on. The aforementioned feedthrough compensation may reduce the display interference of the scan signals on the display device 200.

It should be noted, the touch electrode TED1 corresponds to scan lines LS1˜LS38. Therefore, the number of scan lines corresponding to the said touch electrode (that is, 38 lines) is not an integer multiple of the number of scan lines in a single scan line group (that is, 4 lines). Consequently, the interference generated by the falling edge or rising edge of the scan signals SS37 and SS38 corresponding to the touch electrode TED1 cannot be fully compensated. Similarly, the interference generated by the falling edge or rising edge of the scan signals SS39 and SS40 corresponding to the touch electrode TED2 cannot be fully compensated. As a result, display interference of the display device 200 will occur at position P1 (that is, the compensated display position). The grayscale of the display device 200 at the position P1 will be offset. The position P1 is located on at least one edge of the touch electrodes TED1 and TED2.

In the embodiment, the layout of touch electrodes TED1 and TED2 may be recorded in the setting circuit 223. Therefore, the setting circuit 223 may provide the layout information RL. The processing circuit 222 generates the notification signal SN according to the layout information RL. The notification signal SN includes information about the position P1. Therefore, the setting circuit 223 generates a recognition result RS according to the notification signal SN. The compensation circuit 230 compensates the data corresponding to the position P1 in the image data DIMG according to the recognition result RS.

In the embodiment, when the layout of touch electrodes TED1 and TED2 changes, the setting circuit 223 may provide another different layout information RL according to the layout of the touch electrodes.

The disclosure is not limited to the layout of touch electrodes TED1 and TED2 in the embodiment.

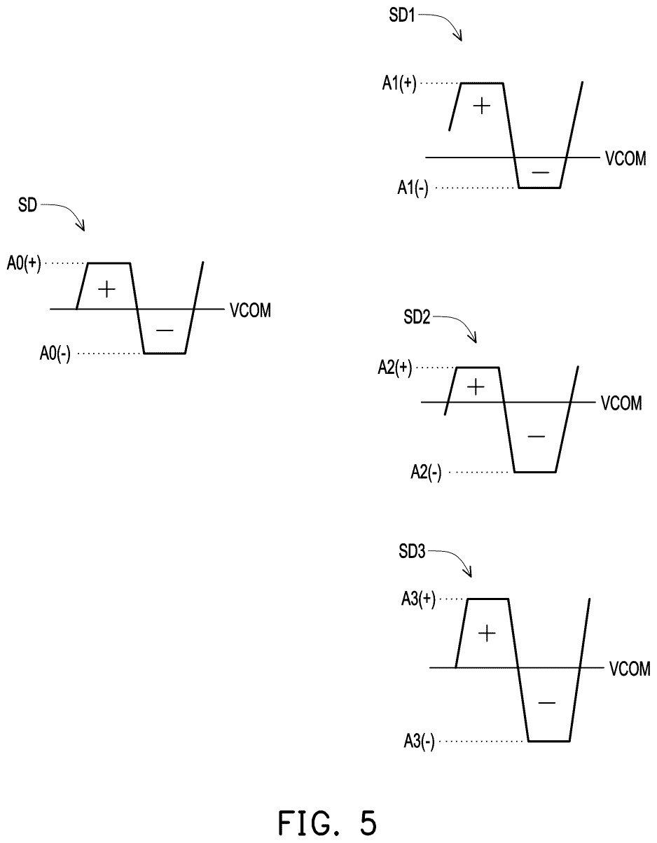

Please refer to FIG. 1 and FIG. 5, FIG. 5 is a schematic diagram of compensation operation drawn according to an embodiment of the disclosure. In the embodiment, FIG. 5 shows an uncompensated data signal SD. When the data signal SD is in the first polarity (for example, positive polarity), the data signal SD has a voltage value A0(+) relative to the common voltage VCOM. When the data signal SD is in the second polarity (for example, negative polarity), the data signal SD has a voltage value A0(−) relative to the common voltage VCOM. Generally, An absolute value of the voltage value A0(+) is approximately the same as an absolute value of the voltage value A0(−).

In an embodiment, the compensation circuit 130 compensates the image data DIMG according to the compensation signal SC to generate the compensated image data DIMG′. Therefore, the data signal SD1 is generated according to the compensated image data DIMG′. A voltage value of the data signal SD1 is shifted. When the data signal SD1 is in the first polarity, the data signal SD1 has a voltage value A1(+) relative to the common voltage VCOM. When the data signal SD1 is in the second polarity, the data signal SD1 has a voltage value A1(−) relative to the common voltage VCOM. An absolute value of the voltage value A1(+) is greater than the absolute value of the voltage value A0(+). An absolute value of the voltage value A1(−) is less than the absolute value of the voltage value A0(−).

In an embodiment, the data signal SD2 is generated according to the compensated image data DIMG′. The voltage value of the data signal SD2 is shifted. When the data signal SD2 is in the first polarity, the data signal SD2 has a voltage value A2(+) relative to the common voltage VCOM. When the data signal SD2 is in the second polarity, the data signal SD2 has a voltage value A2(−) relative to the common voltage VCOM. An absolute value of the voltage value A2(+) is less than the absolute value of the voltage value A0(+). An absolute value of the voltage value A2(−) is greater than the absolute value of the voltage value A0(−).

In an embodiment, the data signal SD3 is generated according to the compensated image data DIMG′. The voltage value of the data signal SD3 is amplified. When the data signal SD3 is in the first polarity, the data signal SD3 has a voltage value A3(+) relative to the common voltage VCOM. When the data signal SD3 is in the second polarity, the data signal SD3 has a voltage value A3(−) relative to the common voltage VCOM. An absolute value of the voltage value A3(+) is greater than the absolute value of the voltage value A0(+). An absolute value of the voltage value A3(−) is greater than the absolute value of the voltage value A0(−).

In an embodiment, the voltage value of the data signal SD3 is reduced.

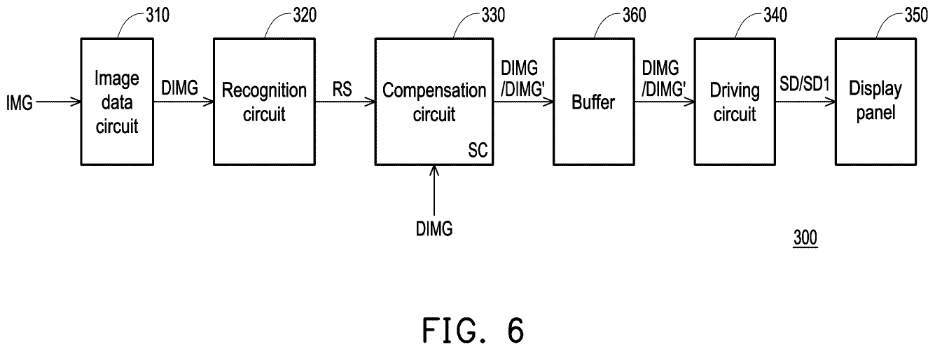

Please refer to FIG. 6, FIG. 6 is a schematic diagram illustrating a display device according to an embodiment of the disclosure. In the embodiment, the display device 300 includes an image data circuit 310, a recognition circuit 320, a compensation circuit 330, a driving circuit 340, a display panel 350, and a buffer 360.

The image data circuit 310 receives the input image IMG and generates image data DIMG according to the input image IMG. The input image IMG may be a data stream. Therefore, the image data circuit 310 may decode the input image IMG to generate the image data DIMG. The image data circuit 310 may be implemented by an image decoder. The recognition circuit 320 is electrically connected to the image data circuit 310. The recognition circuit 320 receives the image data DIMG and recognizes the image data DIMG to generate a recognition result RS. In the embodiment, the compensation circuit 330 is electrically connected to the recognition circuit 320. The compensation circuit 330 generates a compensation signal SC according to the recognition result RS. The compensation circuit 330 compensates the image data DIMG according to the compensation signal SC to generate the compensated image data DIMG′.

The buffer 360 is electrically connected to the compensation circuit 330. The buffer 360 temporarily stores the compensated image data DIMG′. The driving circuit 340 is electrically connected to the buffer 360. The driving circuit 340 generates the data signal SD1 according to the compensated image data DIMG′.

When the compensation signal SC is not received, the buffer 360 temporarily stores the image data DIMG. The display driving circuit 340 then generates the data signal SD according to the image data DIMG.

The display panel 350 displays an image according to one of the data signals SD and SD1.

In the embodiment, the operation method S100 could be applied to the display device 300.

In some embodiments, the recognition circuit 320 and the compensation circuit 330 are integrated in the same chip, however, the disclosure is not limited thereto.

In some embodiments, the image data circuit 310, the recognition circuit 320, the compensation circuit 330, and the buffer 360 may be integrated in the same circuit or chip, however, the disclosure is not limited thereto.

In some embodiments, the display device 300 does not include the buffer 360.

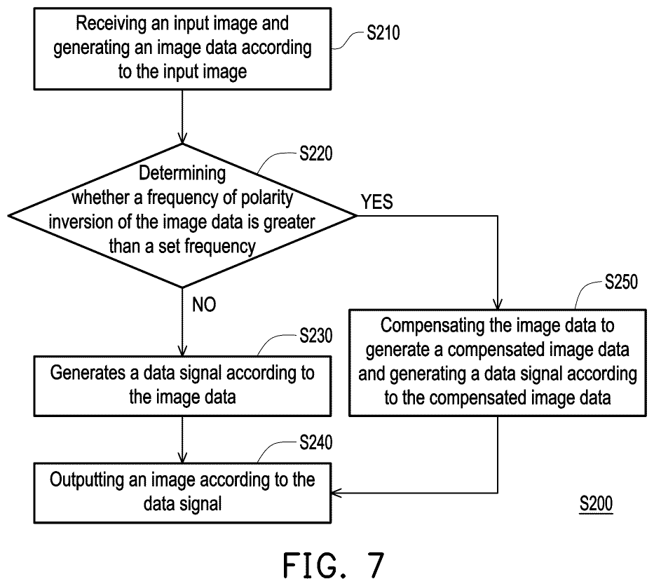

Please refer to FIG. 1 and FIG. 7, FIG. 7 illustrates a flowchart of an operation method according to an embodiment of the disclosure. In the embodiment, the operation method S200 could be applied to the display device 100. The operation method S200 includes steps S210 to S250. In the step S210, the recognition circuit 120 receives the input image IMG and generates the image data DIMG according to the input image IMG. In the step S220, the recognition circuit 120 determines whether the frequency of polarity inversion of the image data DIMG is greater than a set frequency. When the frequency of polarity inversion of the image data DIMG is less than or equal to the set frequency, this indicates that the polarity inversion of the image data DIMG is not frequent and will not interfere with the display of the display device 100. Therefore, the compensation circuit 130 generates the data signal SD according to the image data DIMG in the step S230. The display device 100 outputs an image according to the data signal SD in step S240.

On the other hand, in the step S220, when the frequency of polarity inversion of the image data DIMG is greater than the set frequency, this indicates that the frequent polarity inversion of the image data DIMG may interfere with the display of the display device 100. Therefore, the compensation circuit 130 compensates the image data DIMG to generate the compensated image data DIMG′ in the step S250, and generates the data signal SD1 according to the compensated image data DIMG′. Subsequently, the display device 100 outputs an image according to the data signal SD1 in the step S240.

In the embodiment, the display device 100 may be an automotive display device. Therefore, in the step S210, the display device 100 receives the input image IMG from an automotive host, and generates the image data DIMG according to the input image IMG.

In some embodiments, the operation method S200 could be applied to the display devices 200 or 300. Taking the display device 300 as an example, the buffer 360 stores the image data DIMG in the step S230. Therefore, the driving circuit 340 generates the data signal SD according to the image data DIMG in the step S230. The display panel 350 outputs an image according to the data signal SD in the step S240. Furthermore, the buffer 360 temporarily stores the compensated image data DIMG′ in the step S250. Therefore, the driving circuit 340 generates the data signal SD1 according to the compensated image data DIMG′ in the step S250. The display panel 350 outputs an image according to the data signal SD1 in the step S240.

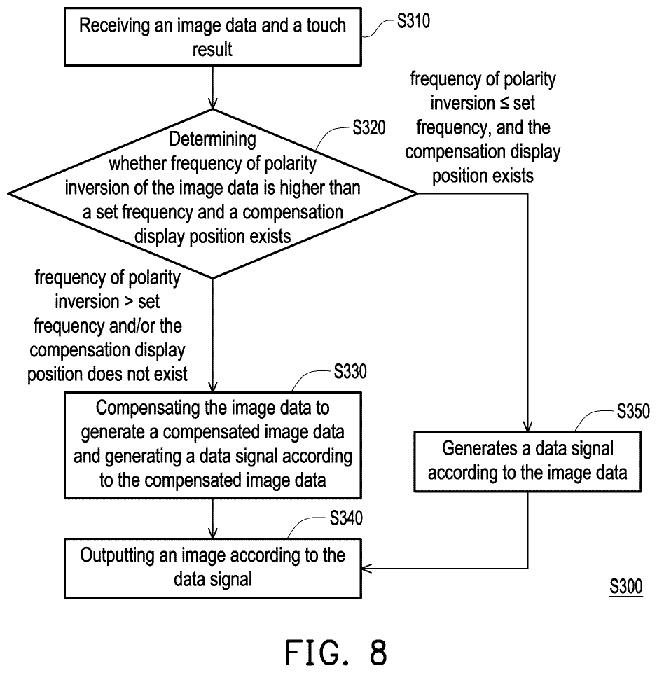

Please refer to FIG. 3 and FIG. 8, FIG. 8 illustrates a flowchart of an operation method according to an embodiment of the present disclosure. In the embodiment, the operation method S300 could be applied to the display device 200. The operation method S300 includes steps S310 to S350. In the step S310, the recognition circuit 220 receives the image data DIMG and the touch result RT. In the step S320, the recognition circuit 220 determines the image data DIMG according to the image data DIMG and the touch result RT.

Furthermore, in step the S320, the recognition circuit 220 obtains the frequency of polarity inversion of the image data DIMG according to the image data DIMG, and determines whether a compensation display position exists according to the touch result RT. When the frequency of polarity inversion is higher than the set frequency and/or the compensation display position exists, the compensation circuit 230 compensates the image data DIMG to generate the compensated image data DIMG′ in the step S330. The display driving circuit 240 generates the data signal SD1 according to the compensated image data DIMG′ in the step S330. The touch display panel 250 receives the data signal SD1 and outputs an image according to the data signal SD1 in the step S340.

On the other hand, in the step S320, when the frequency of polarity inversion is lower than or equal to the set frequency and/or the compensation display position does not exist, the compensation circuit 230 generates the data signal SD according to the image data DIMG in the step S350. The touch display panel 250 outputs an image according to the data signal SD in the step S340.

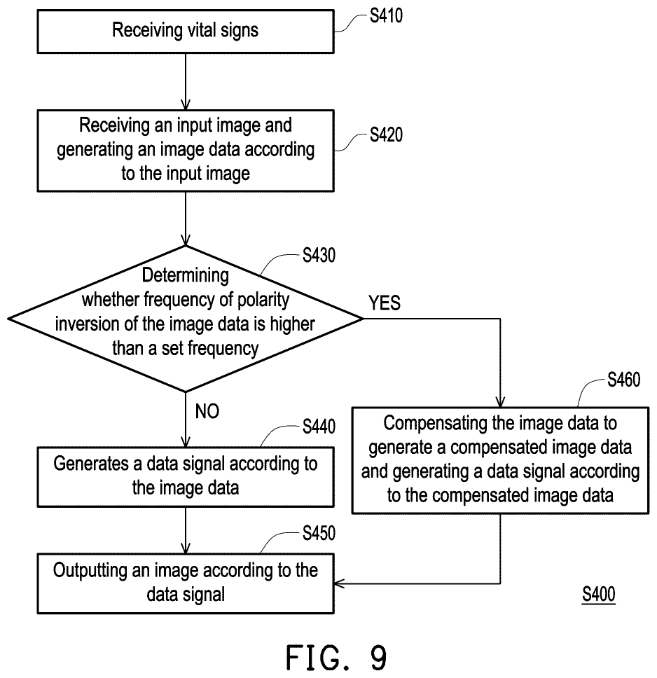

Please refer to FIG. 1 and FIG. 9, FIG. 9 illustrates a flowchart of an operation method according to an embodiment of the disclosure. In the embodiment, the operation method S400 could be applied to the display device 100. The display device 100 may be an automotive instrument panel or an automotive display device. The operation method S400 includes steps S410 to S460. In the step S410, the automotive host receives vital signs. In the step S420, the recognition circuit 120 receives the input image IMG and generates the image data DIMG according to the input image IMG. In the step S430, the recognition circuit 120 determines whether the frequency of polarity inversion of the image data DIMG is greater than the set frequency. When the frequency of polarity inversion of the image data DIMG is less than or equal to the set frequency, the compensation circuit 130 generates the data signal SD according to the image data DIMG in the step S440. The display device 100 outputs an image according to the data signal SD in the step S450. The display device 100 displays information of the user's vital signs (for example, pulse, posture, mental state) according to the data signal SD in the step S450.

On the other hand, in the step S430, when the frequency of polarity inversion of the image data DIMG is greater than the set frequency, the compensation circuit 130 compensates the image data DIMG to generate the compensated image data DIMG′ and generates the data signal SD1 according to the compensated image data DIMG′ in the step S460. Then the display device 100 outputs an image according to the data signal SD1 in the step S450. The display device 100 displays information of the user's vital signs according to the data signal SD1 in the step S450.

In some embodiments, the operation method S400 could be applied to the display device 200 or 300.

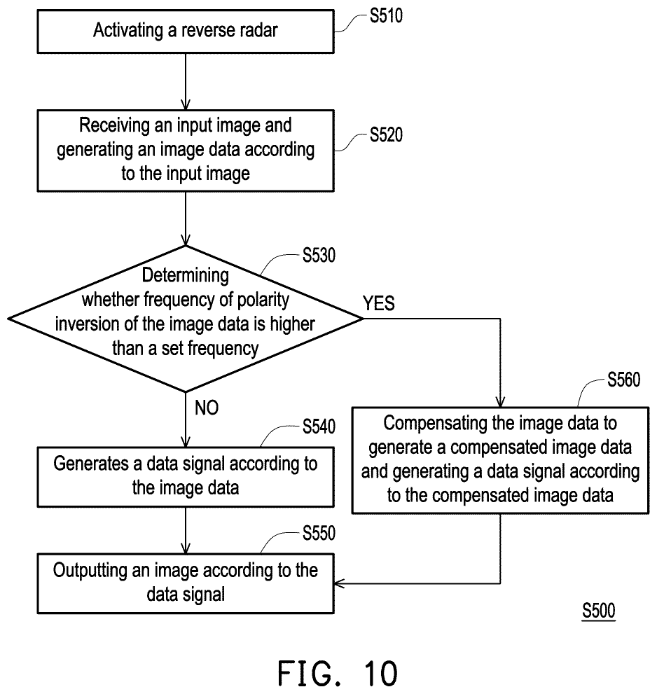

Please refer to FIG. 1 and FIG. 10, FIG. 10 illustrates a flowchart of an operation method according to an embodiment of the disclosure. In the embodiment, the operation method S500 could be applied to the display device 100. The display device 100 may be an automotive display device. The operation method S500 includes steps S510 to S560. In the step S510, the reverse radar is activated. In the step S520, the recognition circuit 120 receives the input image IMG and generates the image data DIMG according to the input image IMG. In the step S530, the recognition circuit 120 determines whether the frequency of polarity inversion of the image data DIMG is greater than the set frequency. When the frequency of polarity inversion of the image data DIMG is less than or equal to the set frequency, the compensation circuit 130 generates the data signal SD according to the image data DIMG in the step S540. The display device 100 outputs an image according to the data signal SD in the step S550. The display device 100 displays an image outside the vehicle according to the data signal SD in the step S550.

On the other hand, in the step S530, when the frequency of polarity inversion of the image data DIMG is greater than the set frequency, the compensation circuit 130 compensates the image data DIMG to generate the compensated image data DIMG′ and generates the data signal SD1 according to the compensated image data DIMG′ in the step S560. Then the display device 100 outputs an image according to the data signal SD1 in the step S550. The display device 100 displays an image outside the vehicle according to the data signal SD1 in the step S550.

In some embodiments, the operation method S400 could be applied to the display device 200 or 300.

In summary, the display device recognizes the image data to generate a recognition result, and generates a compensation signal according to the recognition result. The display device compensates the image data according to the compensation signal. The display device may compensate the image data based on different designs or scenarios. As a result, the grayscale uniformity of the display device may be improved.

Finally, it should be noted that: the above embodiments are only used to illustrate the technical solutions of the disclosure, and are not intended to limit them; although the disclosure has been described in detail with reference to the foregoing embodiments, those skilled in the art should understand that: they may still modify the technical solutions described in the foregoing embodiments, or make equivalent replacements to part or all of the technical features; and these modifications or replacements do not cause the essence of the corresponding technical solutions to deviate from the scope of the technical solutions of the embodiments of the disclosure.

What is claimed is:

1. A display device, comprising:
an image data circuit, configured to output an image data;
a recognition circuit, electrically connected to the image data circuit, and configured to receive the image data, and recognize the image data to generate a recognition result; and
a compensation circuit, electrically connected to the recognition circuit, and configured to generate a compensation signal according to the recognition result, and to compensate the image data according to the compensation signal.

2. The display device of claim 1, wherein the recognition circuit obtains at least one compensation display position of the display device according to the image data, and generates the recognition result according to the at least one compensation display position.

3. The display device of claim 2, wherein:
the display device further comprises a touch electrode and a plurality of scan line groups,
interferences of transitions of a plurality of scan signals of a plurality of scan lines in a same scan line group are compensated for each other,
a number of the plurality of scan lines corresponding to the touch electrode is not an integer multiple of the number of scan lines in a single scan line group, and
the at least one compensation display position is located on at least one edge of the touch electrode.

4. The display device of claim 2, wherein the recognition circuit receives a touch result, and generates the recognition result according to the touch result and the image data.

5. The display device of claim 1, wherein the recognition circuit generates the recognition result according to polarity inversion of the image data.

6. The display device of claim 1, further comprising:
a touch display panel,
wherein the recognition circuit comprises:
a touch sensing circuit, electrically connected to the touch display panel, and configured to receive a touch result from the touch display panel, and convert the touch result into a touch sensing signal; and
a processing circuit, electrically connected to the touch sensing circuit and the image data circuit, and configured to receive the touch sensing signal and the image data, and generate a notification signal according to one of the touch sensing signal and the image data.

7. The display device of claim 6, wherein the recognition circuit further comprises:
a setting circuit, electrically connected to the processing circuit and the compensation circuit, and configured to generate the recognition result according to the notification signal.

8. The display device of claim 7, wherein the processing circuit generates the notification signal according to an inversion frequency of polarity of the image data.

9. The display device of claim 7, wherein the processing circuit generates the notification signal according to a polarity of the image data and a touch position corresponding to the touch sensing signal.

10. The display device of claim 1, wherein the recognition circuit and the compensation circuit are integrated in a same chip.

11. The display device of claim 1, wherein the compensation circuit shifts a voltage value of the image data to generate a compensated image data.

12. The display device of claim 1, wherein the compensation circuit amplifies a voltage value of the image data to generate a compensated image data.

13. The display device of claim 1, wherein the compensation circuit reduces a voltage value of the image data to generate a compensated image data.

14. An operation method for a display device, comprising:
receiving an input image from an automotive host, and generating an image data according to the input image;
receiving the image data, and recognizing the image data to generate a recognition result;
generating a compensation signal according to the recognition result; and
compensating the image data according to the compensation signal.

15. The operation method of claim 14, wherein the step of recognizing the image data to generate the recognition result comprises:
obtaining at least one compensation display position of the display device according to the image data, and generating the recognition result according to the at least one compensation display position.

16. The operation method of claim 15, wherein:
the display device further comprises a touch electrode and a plurality of scan line groups,
interferences of transitions of a plurality of scan signals of a plurality of scan lines in a same scan line group are compensated for each other,
a number of the plurality of scan lines corresponding to the touch electrode is not an integer multiple of the number of scan lines in a single scan line group, and
the at least one compensation display position is located on at least one edge of the touch electrode.

17. The operation method of claim 14, wherein the step of recognizing the image data to generate the recognition result comprises:
generating the recognition result according to polarity inversion of the image data.

18. The operation method of claim 14, wherein the step of compensating the image data according to the compensation signal comprises:
shifting a voltage value of the image data to generate a compensated image data.

19. The operation method of claim 14, wherein the step of compensating the image data according to the compensation signal comprises:
amplifying a voltage value of the image data to generate a compensated image data.

20. The operation method of claim 14, wherein the step of compensating the image data according to the compensation signal comprises:
reducing a voltage value of the image data to generate a compensated image data.
